(19) United States
(12) Patent Application Publication
(10) Pub. No.: US 2002/0083632 A1
(43) Pub. Date: Jul. 4, 2002

(54) Clothing friendly clip

(75) Inventors: Scott M. Hyde, Sudburg, MA (US); Robert N. Brosofsky, Nashua, NH (US); James A. Burditt, Tewksbury, MA (US); Richard M. Raia, Lexington, MA (US)

Correspondence Address: BANNER & WITCOFF, LTD., 28 STATE STREET, 28th FLOOR, BOSTON, MA, 02109, US

(73) Assignee: Comprehensive Identification Products, Inc.

(21) Appl. No.: 09/960,639

(22) Filed: Sep. 21, 2001

Related U.S. Application Data
(60) Provisional application No. 60/234,551, filed on Sep. 22, 2000.

(51) Int. Cl. G09F 3/16; A41F 1/00

(52) U.S. Cl. 40/666; 24/499

(57) ABSTRACT

A clothing-friendly clip with a face member and a base member containing a mounting portion, each having a convex bend at a first end, pivotably connected to one another and biased so as to urge the first ends toward each other around the pivotal connection. A clothing-friendly clip with a face member that comprises a flat body with extensions extending perpendicularly from the sides, a base member with a flat body with extensions extending perpendicularly from the sides, the base member also having a mounting portion, wherein the face member and base member each have a convex bend at a first end and are pivotably connected to one another at the extensions, and wherein a coil spring located between the face member and base member urges the first end of the face member and base member toward one another. A personal document display comprising a clothing-friendly clip with a face member that comprises a flat body with extensions extending perpendicularly from the sides, a base member with a flat body with extensions extending perpendicularly from the sides, the base member also having a mounting portion, wherein the face member and base member each have a convex bend at a first end and are pivotably connected to one another at the extensions, and wherein a coil spring located between the face member and base member urges the first end of the face member and base member toward one another, and a document display mounted to the mounting portion of the base member.

### CROSS-REFERENCE TO RELATED APPLICATION

This application claims priority from copending U.S. Provisional Application, U.S.Ser.No.60/234,551, filed Sep. 22, 2000, the disclosure of which is hereby incorporated herein by reference.

### BACKGROUND OF THE INVENTION

There are many circumstances in which an identification card, badge, name tag, or other type of document must be attached to personal clothing. Current means for attaching such to personal clothing includes adhesive-backed tags, pins, and clips. Each of these means has a deficiency, making them non-ideal. Adhesive-backed tags suffer an inability to remain secured to the clothing over time and an inability to be transferred repeatedly from one item of clothing to the next while retaining adhesion. Pins require the penetration of the clothing to function, thus damaging the clothing upon proper use and damaging the material more severely should the tag become caught or otherwise pulled off. Clips, that is, devices that grip, clasp, or hook the material to which they are attached, do not always damage the clothing to which they are attached; however, virtually all conventional clips available today have the potential to damage clothing. Such presently available clips are typically either of the “bulldog” (overlapping jaws) or “alligator” (serrated teeth) variety. Such clips, while functional in that they securely attach a tag to an item of clothing, these designs, due to the aggressive nature of their hold, risk severely damaging clothing both under normal conditions and when they are accidentally torn off of the clothing.

### SUMMARY OF THE INVENTION

The present invention relates to clips, and more particularly to clips for attaching identification badges, cards, licenses, passes, security clearances, or other document types to clothing while minimizing the risk of damage to the clothing material. In accordance with a first aspect, the clip comprises a face member pivotably connected to a base member, each of the face member and base member having convex ends opposing one another; biasing means for urging the convex face members toward each other; and a mounting portion located at an end of the face member opposite the convex end for mounting the item to be clipped. In accordance with certain preferred embodiments, the biasing means comprises a coil spring.

In accordance with certain preferred embodiments, the inner surface member of the convex end of the face member is smooth. In other preferred embodiments, the inner surface member of the convex portion of the face member is knurled, by which is meant comprising a series of small ridges or beads or other suitable protuberance to aid in gripping the material to which the clip is being attached. In yet other preferred embodiments, the face member and the base member each have one or more extensions extending perpendicularly in the direction of the convex bend, with the pivotable connection taking place at the extensions. In certain preferred embodiments, the pivotable connection is via a pair of eyelets.

In accordance with another preferred embodiment of the present invention, a personal document display comprises a clip comprised of a face member pivotably connected to a base member, each of the face member and base member having convex ends opposing one another; biasing means for urging the convex face members toward each other; a mounting portion located at an end of the face member opposite the convex end; and a document display mounted to the mounting portion of the face member.

This invention offers two opposing pieces under tension to one another such that any item, such as clothing, when positioned between the two pieces is retained in place and eliminates the possibility of damage to clothing that exists in most designs presently available specifically for attaching documents to clothing. This arrangement offers a simple convenient, finger-operated system that can be inexpensively manufactured in common steel or brass.

It is an object of the present invention to provide an alternate clip for attaching document displays to clothing. It is another object of the present invention to overcome some or all of the deficiencies of the document display means described above. It is a further object of the present invention to provide a clip that limits the potential for damage to clothing by offering opposing curved surface members that offer sufficient grip to secure a document display to clothing through most normal environments while retaining a smooth surface member such that the clip can be pulled off of the clothing without damaging the material. As such, the present invention will be particularly useful in those environments where the document is issued on a temporary basis such as for meeting, trade shows or conventions. Additional aspects, features, and advantages of the document display clips disclosed here will be apparent from the following detailed description of certain preferred embodiments.

A “convex bend” as used herein refers to a bend that is convex with respect to the plane that extends through the central pivot 18 and through the contact line of the front ends of the face member and base members 2 and 3 when the clip is closed, i.e., the plane that substantially corresponds with the piece of material to which the clip is clipped. In other words, a “convex bend” as used herein is one that curves inward toward the opposing front end and then back away from the opposing front end.

The term “inner surface member” as used herein is the surface member which face members toward the plane that extends through the central pivot 18 and through the contact line of the front ends of the face member and base members 2 and 3 when the clip is closed, i.e., the plane that substantially corresponds with the piece of material to which the clip is clipped.

The term “stippled” as used herein means comprising a series of indentations, typically rounded in shape.

The term “knurled” as used herein means comprising a series of small ridges or beads or other suitable protuberances.

The term “personal document display” as used herein refers to the clip, the document to be displayed, a document holder where appropriate, and the mounting means used to attach the document to the clip, all in combination.

The term “document display” as used herein refers to the item actually mounted to the clip, typically either a card containing the information sought to be displayed or a sleeve capable of accepting the document to be displayed.

The term “face member” as used herein refers to the portion of the clip that typically faces the clothing when the clip is attached to clothing; the term “base member” as used herein typically refers to the portion of the clip that faces away from the clothing, i.e., the part of the clip that attaches to the side of the clothing material visible to the observer. It is understood that the clip, if clipped such that the convex front ends face upwardly, is still capable of displaying a document when the face member side is facing away from the clothing.

As described herein, the preferred Clothing Friendly™ clip comprises a face member and a base member spring-pivotably connected to one another about a pivot axis. The face member and the base member may comprise steel, brass, or other metal, and each of the face member and base member may be stamped out of a single sheet of the metal. Optionally, the face member and base member could comprise plastic such as injection-molded thermoplastic. Other suitable materials will be readily apparent to those skilled in the art, given the benefits of this disclosure.

In certain preferred embodiments, the face member and the base member will each comprise a flat body extending substantially parallel to the axis of the pivotal connection of the face member and base member. At a front end of each of the face member and the base member will be a convex bend such that the bends curve in toward the inner sides, i.e., sides facing the pivotal connection, of the bodies and then back outwardly. The body of the face member typically will extend in equal or semi-equal amounts to either side of the pivot axis. The body of the base member will typically extend similarly, but will additionally comprise a mounting portion typically located at a second end remote from the front end of the base member. A biasing member, preferably a spring, typically located between the face member and the base member, operates to urge the first ends of the face member and base member toward each other around the pivotal connection.

The body of the face member and base member will in certain preferred embodiments have extensions extending substantially perpendicularly from the sides toward the center of the clip, i.e., toward the plane passing through the pivot axis and the point of contact between the front ends of the face member and the base member. These extensions typically define a hole that corresponds with the pivot axis. These holes can be used to pivotably connect the face member and the base member. Such a connection can be by means of a rivet, a pair of eyelets, or a pair of rivets. In certain preferred embodiments, either the face member or the base member may comprise a single central extension extending from a central portion of flat body toward the center of the clip. This single extension may define a circular hole at or near the middle of the body that corresponds with the pivot axis. Pivotal connection could then be made via a rivet extending through the holes defined by the extensions.

The shape of the convex bends found in the front ends of the face member and base member, when viewed from the side angle, typically comprise substantially an arc of a circle. In certain preferred embodiments, the radius of the circle to which the arc of the bend in the face member corresponds differs from that of the bend in the base member, while in other preferred embodiments these radii may be the same. In yet other preferred embodiments, the shape of the bend may not correspond to an arc of a circle but rather correspond to a rounded meeting of two lines or arcs or combination thereof. Other suitable bend shapes will be readily apparent to those skilled in the art, given the benefit of the present disclosure.

The shape of the front ends of the face member and the base member, when viewed outwardly from the center, is typically rectangular, and typically the corners are rounded. The width typically corresponds to the width of the flat bodies of the face member and base members and typically the width of one front end corresponds to the width of the other front end. Greater widths are utilized in certain preferred embodiments to result in greater surface member area with which to grip the clothing material. Other suitable shapes and dimensions of the front ends relative to the remainder of the clip will be readily apparent to those skilled in the art, given the benefits of the present disclosure.

The length of the base member relative to the face member may be varied to accommodate variable hole positions and diameters to accommodate various mounting means for mounting a document display to the clip. Such mounting means may typically include rivets, eyelets, snaps, or straps. Other suitable mounting means will be readily apparent to those skilled in the art, given the benefits of the present disclosure.

As described above, the biasing member may in certain preferred embodiments comprise a coil spring with multiple windings, located between the face member and the base member. The coil spring may be located such that the windings wind around the rivet that joins the face member and base members. In other preferred embodiments, the coil spring windings will generally wrap around the pivot axis. The coil spring may in yet other preferred embodiments be located at any position such that it urges the front ends of the face member and the base member against each other. Varying the number of windings of the coil spring may control the force at which the front ends are held together. Further, in certain preferred embodiments, the biasing member may serve as both the biasing member and as the means for pivotably connecting the base member and the face member, i.e., with no further rivets or eyelets connecting the face member and base members. Other suitable configurations for a coil spring will be readily apparent to those skilled in the art, given the benefit of the present disclosure.

In other preferred embodiments, the biasing member may comprise a leaf spring located between the face member and the base member. Alternatively, the biasing member can be an extension of the rear portion of flat body of the face member, bent toward the center of the clip to contact the inner surface member of the flat body of the base member such that it acts as a leaf spring. Similarly, the biasing member can be an extension of the rear portion of flat body of the base member, bent toward the center of the clip to contact the inner surface member of the flat body of the face member such that it acts as a leaf spring. The biasing member may comprise a single coil spring or leaf spring or may comprise multiple springs. Alternate configurations for the coil spring or leaf spring and alternate biasing members will be readily apparent to those skilled in the art, given the benefits of the current disclosure.

In certain preferred embodiments, the inner surface member of the front end of the face member is smooth. In other preferred embodiments, inner surface member may be stippled. In still other preferred embodiments, inner surface member may be knurled. In yet other preferred embodiments, inner surface member may be coated or covered with a plastic or rubber material to aid in gripping, which itself may be stippled, knurled, or smooth.

Advantageously, the inner surface member of the front end of the base member is smooth to avoid marring the surface member of the material to which it is attached. The inner surface member of the front end of the base member may in other preferred embodiments may also be stippled, knurled, or coated or covered with a plastic or rubber material which itself may be smooth, stippled, or knurled. Other configurations of the inner surface member of the front end of the face member and the base member will be readily apparent to those skilled in the art, given the benefits of the present disclosure.

### BRIEF DESCRIPTION OF THE DRAWINGS

FIG. 1 illustrates a preferred embodiment of the Clothing Friendly™ clip of the present invention from a side view.

FIG. 2 illustrates the base member of a preferred embodiment, prior to stamping, bending or forming to the shapes shown in FIGS. 3, 4 and 5.

FIG. 3 illustrates the component part shown in FIG. 2, after stamping, bending or forming, in side view.

FIG. 4 is a cross-sectional view of the component part shown in FIG. 3.

FIG. 5 illustrates, from a top view, the base member, with the broken lines indicating the portions projecting downwardly in the shape shown in FIGS. 3 and 4.

FIG. 6 illustrates the inner surface of the face member of a preferred embodiment, prior to stamping, bending or forming to the shapes shown in FIGS. 3, 4 and 5. Shown at the top section is the optional knurling at the tip end.

FIG. 7 illustrates the preferred face member in a side view after stamping, bending or forming.

FIG. 8 is a cross-sectional view of the face member shown in FIG. 7.

FIG. 9 illustrates, from a top view, the face member, with the broken lines indicating the portions projecting downwardly in the shape shown in FIGS. 7 and 8.

### DETAILED DESCRIPTION OF THE PREFERRED EMBODIMENTS

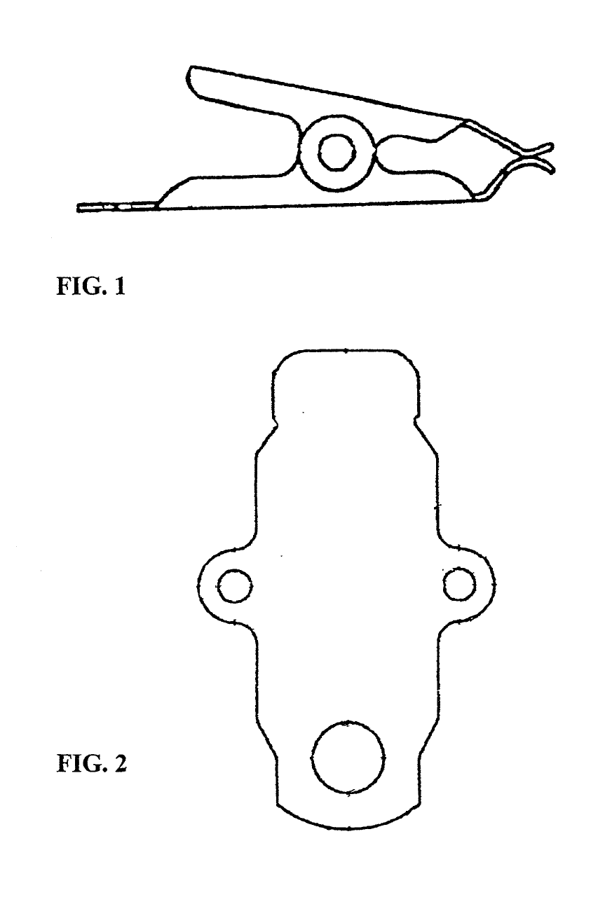

An especially preferred embodiment of the “Clothing Friendly” clip is displayed in FIGS. 1-9. In these figures, clip 1 comprises a face member 2 and a base member 3. Face member 2 comprises a flat body 4 with a convex bend located at a front end 5. A pair of extensions 6 extend substantially perpendicularly from the side edges 7 of the body in the same direction as the convex bend. The extensions define a circular hole 8 at or near the middle of the body such that the center 9 of the circular hole lies below the remainder of the extension.

Base member 3 similarly comprises a flat body 10 with a convex bend located at a front end 11. A pair of extensions 12 extend substantially perpendicularly from the side edges 13 of the body in the same direction as the convex bend. The extensions define a circular hole 14 at or near the middle of the body such that the center 15 of the circular hole lies below the remainder of the extension. The flat body 10 of the face member 3 further comprises a mounting portion 16 located at the back end of the body, extending beyond the rearmost part of the extensions 12. The mounting portion 16 typically defines a circular mounting hole 17, to which a mounting apparatus can be attached. The base member is also typically stamped from a flat piece of metal and bent into the desired configuration.

The face member 2 and the base member 3 are pivotably connected such that both pivot about a common pivot axis 18. The pivot axis extends substantially parallel to the flat body of the base member and substantially parallel to the flat body of the face member and typically extends substantially through the center 9 of the circular hole 8 defined by the extensions 6 of the face member and through the center 15 of the circular hole 14 defined by the extensions 12 of the base member. The connection in certain preferred embodiments comprises a rivet extending through circular holes 8 and 14 of extensions 6 and 12.

In other preferred embodiments, the connection comprises a pair of rivets, one extending through the circular holes 8 and 14 on one side of the clip and the other through circular holes 8 and 14 on the other side of the clip. In still other preferred embodiments the connection comprises a pair of pivotable eyelet connections, one extending through the circular holes 8 and 14 on one side of the clip and the other through circular holes 8 and 14 on the other side of the clip.

The clip further comprises a coil spring urging the base member 3 and the face member 2 about the common pivot 18 such that the front ends 5 and 11 are closed against each other. The coil spring (not shown) is preferably located such that the windings wind around the rivet that joins the face member and base members. In other preferred embodiments, the coil spring windings will generally wrap around the common pivot 18. The coil spring may in yet other preferred embodiments be located at any position such that it urges the front ends 5 and 11 against each other.

The inner surface member 19 of the front end 5 of the face member 2 is smooth. Advantageously, the inner surface member of the front end 11 of the base member is smooth to avoid marring the surface member of the material to which it is attached.

In this especially preferred embodiment, the invention comprises two, separately stamped, flat metal planes (face member and base member) each formed with one rounded end and opposing, smooth, convex surface members to form a jaw. A positioned, multiple-turn coil-spring offering juxtaposed pressure to the opposing, discreetly designed, and convex surface members join the opposing planes. This coil-spring is a conventional coil spring with multiple-windings, the number of which may vary depending on absolute force required to deliver the desired tension at the interface member of the jaws.

The preferred embodiment provides an optimized jaw shape, but variations can readily be envisioned to also provide adequate attaching force area. A “stipple” surface member is added to the convex surface member of the face member plane to minimize “slippage” on materials with slick finishes. Such a surface member will be “inboard” of pockets, lapels, etc, so that even on the most delicate fabrics, marring will not be noticeable. Conversely, the “stippling” can be eliminated where not desired.

Further, it is possible to use a variety of base member lengths (in relation to face member lengths) to accommodate a variable hole positions and diameters to accommodate standard riveting or eyeleting assembly methods to ID badges or name tags.

The “Clothing Friendly” device provides a safe, alternative replacement for conventional “bull dog” and “alligator” style clips by providing not only the added feature of eliminating damage to clothes, but will also result in a cost which will be competitive.

It will be understood by those skilled in the art that the Clothing Friendly™ clips and personal document displays disclosed and described herein are suitable for use in numerous applications, including name or identification tags, badges or security passes, visitor passes, fishing or hunting licenses, and radiation exposure badges. For purposes of illustration, various preferred and alternative features and aspects of the invention are now described in the context of an identification badge.

In accordance with another aspect of the present invention, a personal document display comprises a clip as described above with a document display mounted to the clip. The document display may in certain preferred embodiments comprise a card or card-like plate with at least a front face member capable of accepting graphic, photographic, pictorial, alpha-numeric, magnetic, or bar-code information or other information or material as desired for display. Such a card will generally be substantially rectangular but may be any suitable shape. The card will have suitable mounting means, further described below, attached directly to it. In other preferred embodiments, the document display comprises a sleeve capable of accepting a card as described generally above, a paper document, or other information-containing format. The sleeve will itself contain mounting means for mounting to the clip, such that the item being displayed need not have mounting means directly attached. The sleeve typically consists of plastic, typically clear on at least a front face member to permit observation of the document contained therein. Other suitable sleeve materials, and other suitable document displays, will be readily apparent to those skilled in the art, given the benefit of the present disclosure.

Mounting means for mounting a document display to the clip include snaps, rivets, both rigid and pivotable, eyelets, and straps. In certain preferred embodiments, the document display is riveted to the mounting portion of the base member, preferably rotatably. This provides a more secure mounting than does the snap or strap mounting means, but makes changing of the document display difficult. In other preferred embodiments, one half of a snap is mounted to the mounting portion of the base member and the other half of the snap is mounted to the document display. Preferably, one or both snap halves are rotatably mounted. Mounting the document display is achieved by snapping the snap halves together. This provides easy changing of the document display from the clip. In yet other preferred embodiments, the document display is mounted to the mounting portion via an eyelet. In still other preferred embodiments, a strap is mounted at a first end to the clip, typically pivotably. The strap is comprised of a flexible, resilient material such as plastic, and contains means for securing a second end to the first end, typically by means of a snap. The strap extends through a slot in the document display and snaps back onto itself, securing the display. This also provides for easy changing of the document display, and has the further advantage of simplifying the requirements of the document display itself; nothing need be mounted to the display.

Additionally, the document display could be attached to a retractable cord, with the retractor mounting attached to the clip, so that the document display could be pulled from the area of the clothing to which it is attached without necessitating unclipping the personal document display. Such would be particularly useful where magnetic or barcode information was required to be scanned or read, such as to unlock a door or punch in and out at the start and end of a shift. Other suitable mounting means will be readily apparent to those skilled in the art, given the benefit of the present disclosure.

In addition to displaying information as described above, the document display may contain other items that are desired to be attached to personal clothing. Examples include radiation exposure detectors, notepads, and the like.

### EXAMPLE

One especially preferred material used for formation of the Clothing Friendly™ clip of this invention (FIGS. 1-7) is cold rolled steel—SAE 1095, with a thickness of 0.017 inches.

Referring to FIG. 1, the preferred dimensions are base length (measured from tip to tip)—1.262 inches (32.09 mm). Distance from base arm to face arm (outside dimension) is 0.370 inches (9.40 mm).

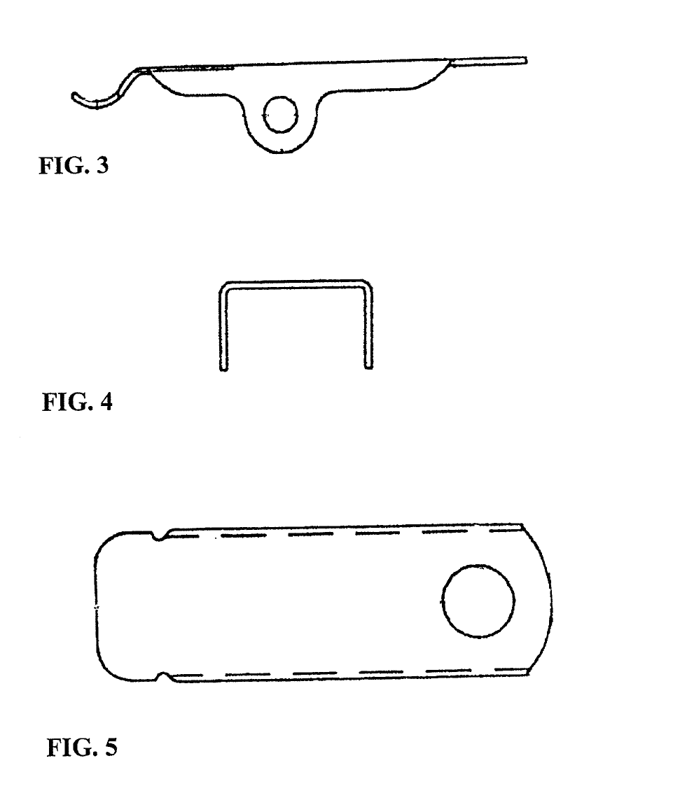

Referring to FIG. 2, the preferred dimensions of the base member before forming (e.g., bending to the shapes shown in FIGS. 3, 4 and 5) include the following; overall length—1.300 inches (33.02 mm); maximum width—0.820 inches (20.83 mm); tip length—0.193 inches (4.91 mm); tip width—0.400 inches (10.16 mm); width at mounting hole end—0.390 inches (20.83 mm); width of straight sections on either side of the mounting holes—0.500 inches (12.70 mm); angle between the straight sections and the tip sides—142°; radius of the junction between the tip section and the straight sections—R 0.014 inches (R 0.35 mm); radius of the tip section edges—R 0.094 (R 2.39 mm); radius at mounting hole end—R 0.313 inches (R 7.94 mm); diameter of the mounting hole —0.195 inches (∅4.95 mm); first radii from the mounting hole end—R 0.030 inches (R 0.76 mm); radii around the pivot holes—R 0.060 inches (R 1.52 mm); diameter of the material surrounding the pivot holes—0.200 inches (∅5.08 mm); diameter of the pivot holes—0.090 inches (∅2.29 mm).

Referring to FIG. 3, additional preferred dimensions of the base member include the following; radius of the tip—R 0.094 inches (R 2.39 mm); distance between tip end and the plane of the base member—0.064 inches (1.63 mm); distance between the center of the pivot hole and the lowest point on the convex tip—0.509 inches (12.93 mm); distance between the center of the pivot hole and the plane of the base member—0.135 inches (3.43 mm);

Referring to FIG. 4, the gap between the bent arms of the base member is 0.375 inches (9.53 mm);

Referring to FIG. 5, the base member (with the bending shown in FIGS. 3 and 4) has the following preferred dimensions;—0.410 inches (10.41 mm) and length—1.262 inches (32.07 mm);

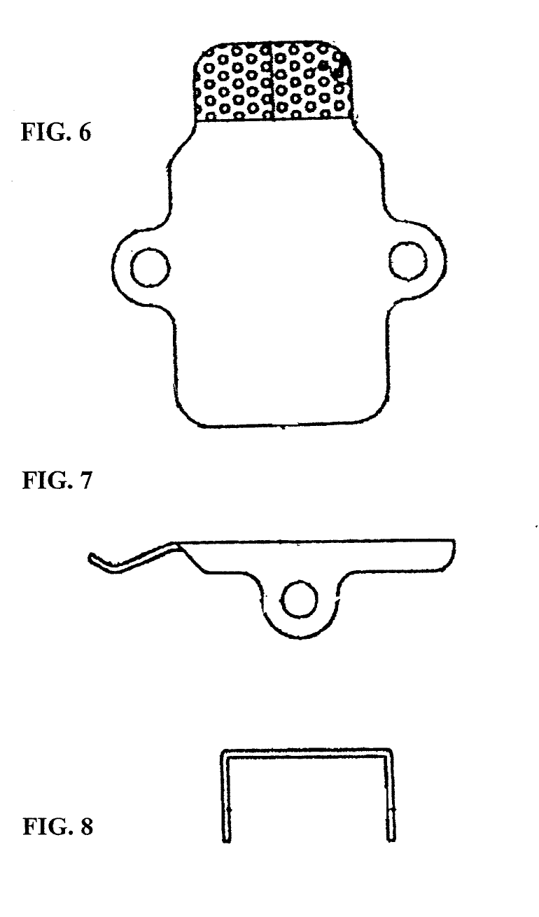

Referring to FIG. 6, the preferred dimensions of the face member before forming (e.g., bending to the shapes shown in FIGS. 7, 8 and 9) include the following; overall length—1.000 inches (25.40 mm); maximum width—0.880 inches (22.35 mm); tip length—0.207 inches (5.25 mm); tip width—0.560 inches (10.45 mm); width at back end—0.560 inches (14.22 mm); width of straight sections on either side of the mounting holes—0.560 inches (14.22 mm); angle between the straight sections and the tip sides—137°; radius of the junction between the tip section and the straight sections—R 0.060 inches (R 1.52 mm); radius of the tip section edges—R 0.094 (R 2.38 mm); radius at the sides of the back end—R 0.094 inches (R 2.38 mm); width of the material surrounding the pivot holes—0.200 inches (∅05.08 mm); diameter of the pivot holes—0.100 inches (∅02.54 mm).

Referring to FIG. 7, additional preferred dimensions of the face member include the following; overall length—0.976 inches (24.79 mm); radius of the tip bend—R 0.031 inches (R 0.79 mm); bend angle formed by two sides at the tip—130°; distance from the tip end to the center of the bend—0.060 inches (1.87 mm); distance between tip end and the upper plane (as illustrated) of the face member—0.025 inches (0.63 mm); distance between the center of the tip bend and the upper plane of the face member—0.074 inches (1.87 mm); distance between the center of the pivot hole and the bend point on the tip—0.496 inches (12.59 mm); distance between the center of the pivot hole and the plane of the face member—0.150 inches (3.81 mm);

As further shown in FIG. 7, the tip section may include knurling to assist in the gripping action of the clip. As illustrated, the raised diamond knurls have a pitch of 0.030 inches, and the material thickness ranges from 0.020 to 0.025 inches after knurling.

Referring to FIG. 8, the gap between the bent arms of the face member is 0.420 inches (10.56 mm); and

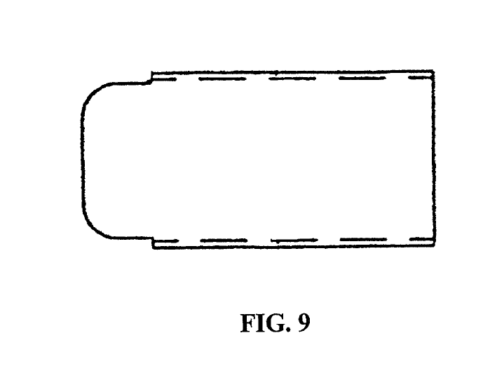

Referring to FIG. 9, the face member (with the bending shown in FIGS. 7 and 8) has a width of 0.462 inches (11.73 mm). As shown therein, the optional knurl is on the far side (or “inside”) to the tip.

The present invention has been described in detail, including the preferred embodiments thereof. However, it will be appreciated that those skilled in the art, upon consideration of the present disclosure, may make modifications and/or improvements on this invention and still be within the scope and spirit of this invention as set forth in the following claims.

What is claimed is:

1. A clip comprising:
a face member with a convex bend at a first end having an inner face member, pivotably connected to a base member having a concave bend at a first end and a mounting portion at a second end; and
a biasing member urging the first end of the face member toward the first end of the base member.

2. The clip of claim 1, wherein the inner face member of the convex bend of the face member comprises a smooth surface member.

3. The clip of claim 1, wherein the inner face member of the convex bend of the face member comprises a knurled surface member.

4. The clip of claim 1, wherein the face member and the base member comprise steel.

5. The clip of claim 4, wherein the steel is cold rolled steel.

6. The clip of claim 1, wherein the face member and the base member comprise brass.

7. The clip of claim 1, wherein the face member and the base member are composed of a single piece.

8. The clip of claim 1, wherein the biasing means comprises a leaf spring.

9. The clip of claim 1, wherein the biasing means comprises a coil spring.

10. A clip comprising:
a face member comprising:
a first end with a convex bend therein, comprising an outer surface member and an inner surface member;
a second end;
two side edges; and at least one extension extending away from the inner surface member, defining an opening;
a base member comprising:
a first end with a convex bend therein, comprising an outer surface member and an inner surface member;
a second end defining a circular hole;
two side edges; and
at least one extension extending away from the inner surface member, defining an opening;
fastening means for pivotably fastening the face member to the base member; and
a coil spring operative to urge the first end of the face member toward the first end of the base member.

11. The clip of claim 10, wherein both the face member and the base member each comprise a pair of extensions, one on each side edge, extending substantially perpendicularly from the inner surface member, each extension defining matching circular openings.

12. The clip of claim 10, wherein the inner surface member of the first end of the face member is smooth.

13. The clip of claim 10, wherein the inner surface member of the first end of the face member is knurled.

14.The clip of claim 10, wherein the fastening means comprises a rivet.

15.The clip of claim 10, wherein the face member and the base member each comprise a single piece of metal.

16.A personal document display comprising:
a clip comprising:
a face member comprising:
a first end with a convex bend therein, comprising an outer surface member and an inner surface member;
a second end;
two side edges; and at least one extension extending away from the inner surface member, defining an opening;
a base member comprising:
a first end with a convex bend therein, comprising an outer surface member and an inner surface member;
a second end defining a circular hole;
two side edges; and
at least one extension extending away from the inner surface member, defining an opening;
fastening means for pivotably fastening the face member to the base member; and
a coil spring operative to urge the first end of the face member toward the first end of the base member;
a document display pivotably mounted to the base member at the circular hole.

17. The personal document display of claim 16, wherein the document display comprises a clear sleeve operable to accept a document.

18. The personal document display of claim 16, wherein the document display comprises a card operative to accept graphic, photographic, alphanumeric, bar code, and/or magnetic information.

19. The clip of claim 1 wherein the convex ends of the face member and the base member are each coated or covered or encased in a plastic or rubber material or material providing greater friction with clothing material.
